(19) United States
(12) Patent Application Publication
(10) Pub. No.: US 2025/0315297 A1
(43) Pub. Date: Oct. 9, 2025

(54) Adaptive Foundation Models Operations in a constrained resource environment

(71) Applicant: International Business Machines Corporation, Armonk, NY (US)

(72) Inventors: Maroun Touma, Redding, CT (US); Alexei Karve, Mohegan Lake, NY (US); Divyansh Jhunjhunwala, Pittsburgh, PA (US); Praneet Adusumilli, Somerset, NJ (US)

(21) Appl. No.: 18/625,757

(22) Filed: Apr. 3, 2024

(51) Int. Cl. G06F 9/50

(52) U.S. Cl. CPC G06F 9/5027; G06F 9/5077

(57) ABSTRACT

A system for resource allocation is provided. The system determines first request data of a first queue. The first queue comprises first tasks associated with a first operation of a first model. The system determines confidence data of an output of each of the first tasks. The system allocates second tasks to a second queue based on the confidence data. The system determines second request data of the second queue. The second queue comprises the second tasks associated with a second operation of the first model. The system generates a policy for resource allocation using a second model based on the first request data, the confidence data, and the second request data. The second model is configured to generate the policy based on a reward function. The system controls allocation of resources for the first operation and the second operation based on the policy.

### BACKGROUND

The present disclosure relates to resource allocation and, more particularly, to dynamic resource allocation for efficient execution of operations of a model based on a policy.

With advancements in the field of artificial intelligence (AI), pre-trained models have become indispensable tools in various AI applications relating to diverse modalities, such as natural language, images, and other structured data. These models are used to perform a multitude of downstream tasks, including natural language processing, computer vision, and speech recognition. However, the use of pre-trained models poses challenges in terms of computational efficiency, particularly during inference and fine-tune operations. With the previous generation of AI techniques, training an AI model that could summarize bodies of text may require a multitude of labeled examples for basic use cases, such as summarization.

Pre-trained models, such as foundation models are a paradigm shift from narrow AI for specific domains to broad AI that learns generally and works across domains and problems. A foundation model is pretrained to perform a range of tasks that may reduce labeled data requirements dramatically. For example, a foundation model that is trained on unlabeled data may be fine-tuned using domain-specific unlabeled corpus to create a domain-specific foundation model. Further, using a much smaller amount of labeled data, the domain-specific foundation model may be further trained for a specific task, such as summarization.

Inference operation involves using a pre-trained model to make predictions on new data inputs, while fine-tune operation involves updating parameters of a pre-trained model based on additional data to improve its performance on specific tasks. Both operations require significant computational resources, including processing units (e.g., central processing units (CPUs), and graphics processing units (GPUs)) and memory, to execute efficiently. However, the resource requirements for the inference operation and the fine-tune operation may vary depending on factors such as input data characteristics, model complexity, and system configurations. In addition, scarcity of resources in certain computing environments exacerbates the challenge of efficient resource allocation.

In particular, cost associated with fine-tuning operations may have to be weighed with an improvement in the efficiency and accuracy of the pre-trained model with effective number of parameters. Epochs is a number of learning runs that are repeated on the same dataset. Generally, with more epochs during the fine-tuning operations, the pre-trained model learns more from the dataset and reduces the training error, thereby improving accuracy during the inference operations. However, if too many epochs are used, the pre-trained model may overfit the dataset and lose its ability to generalize to unseen situations. Confidence scoring enables to trust that outputs of the pre-trained model are reliable. Confidence scoring produces a score that quantifies an extent to which the outputs may be trusted. If confidence is low, further investigation is warranted.

Existing approaches for resource allocation in AI systems often rely on static allocation strategies that allocate fixed amount or number of resources to conduct the inference operation and the fine-tune operation regardless of workload dynamics and resource limitations. Static allocation fails to address the dynamic nature of the operations and the constraints of computing environments. Consequently, static allocation approaches lead to underutilization of resources during periods of low workload and resource contention during peak workload scenarios, thereby hindering system performance and exacerbating resource constraints of computing environments.

### SUMMARY

According to an embodiment of the present disclosure, a system for resource allocation is described. The system comprises a memory that stores instructions and a processor configured to execute the instructions to determine first request data associated with a first queue. The first queue includes one or more first tasks associated with a first operation of a first model. The processor is configured to execute the instructions to determine confidence data associated with an output of each of the one or more first tasks and allocate one or more second tasks to a second queue based on the confidence data of each of the one or more first tasks. The processor is configured to execute the instructions to determine second request data associated with the second queue. The second queue includes one or more second tasks associated with a second operation of the first model. The processor is configured to execute the instructions to generate a policy for resource allocation using a second model based on the first request data, the confidence data, and the second request data. The second model is configured to generate the policy based on a reward function. The processor is configured to execute the instructions to control allocation of one or more resources for each of the first operation and the second operation based on the policy.

According to an embodiment of the present disclosure, a computer-implemented method for resource allocation is described. The method includes processing one or more first tasks from a first queue using a first model. The one or more first tasks are associated with a first operation of the first model. The method includes determining a confidence score for an output of each of the one or more first tasks. The method includes allocating one or more second tasks to a second queue based on the confidence score. The one or more second tasks are associated with a second operation of the first model. The method includes determining first request data associated with the first queue, second request data associated with the second queue, and confidence data associated with the confidence score of each of the one or more first tasks. The method includes generating a policy for resource allocation based on the first request data, the confidence data, and the second request data, using a second model. The second model is configured to generate the policy based on a reward function. The method includes controlling allocation of one or more resources for each of the first operation and the second operation based on the policy.

According to an embodiment of the present disclosure, a computer program product for resource allocation is described. The computer program product comprises a computer readable storage medium having program instructions embodied therewith. The program instructions are executable by a processor to cause the processor to determine first request data associated with a first queue. The first queue includes one or more first tasks associated with a first operation of a first model. The program instructions cause the processor to determine confidence data associated with an output of each of the one or more first tasks, allocate one or more second tasks to a second queue based on the confidence data of each of the one or more first tasks, determine second request data associated with the second queue, and generate a policy for resource allocation using a second model based on the first request data, the confidence data, and the second request data. The second queue includes the one or more second tasks associated with a second operation of the first model. The second model is configured to generate the policy based on a reward function. The program instructions cause the processor to control allocation of one or more resources for each of the first operation and the second operation based on the policy.

Some embodiments of the disclosure describe an application of the system, the computer-implemented method, and the computer program product in computing environments in which the first model is executed with constrained resources. The disclosed second model generates a policy to allocate resources to the first model for performing different operations. The dynamic resource allocation improves performance of the first model while performing the different operations.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for resource allocation, in accordance with an embodiment of the disclosure;

FIG. 2 is a diagram that illustrates a network environment in which a system for resource allocation is implemented, in accordance with an embodiment of the disclosure;

FIG. 3A and FIG. 3B are diagrams that depict execution of an exemplary first operation and an exemplary second operation associated with a first model, in accordance with an embodiment of the disclosure;

FIG. 4 is a flowchart that illustrates an exemplary method for generating a second queue for a second operation, in accordance with an embodiment of the disclosure;

FIG. 5 is a diagram that illustrates a diagram for resource allocation for executing the exemplary first operation and the exemplary second operation associated with the first model, in accordance with an embodiment of the disclosure;

FIG. 6 is a diagram of an exemplary problem formulation for resource allocation using a second model, in accordance with an embodiment of the disclosure; and

FIG. 7 is a flowchart that illustrates an exemplary method for dynamic resource allocation based on a policy, in accordance with an embodiment of the disclosure.

### DETAILED DESCRIPTION

According to an aspect of the present disclosure, there is provided a system for dynamic resource allocation. The system comprises a memory that stores instructions and a processor configured to execute the instructions. The processor is configured to determine first request data associated with a first queue. The first queue includes one or more first tasks associated with a first operation of a first model. The processor is configured to determine confidence data associated with an output of each of the one or more first tasks. The processor is configured to allocate one or more second tasks to a second queue based on the confidence data of each of the one or more first tasks. The processor is configured to determine second request data associated with the second queue. The second queue includes the one or more second tasks associated with a second operation of the first model. The processor is configured to generate a policy for resource allocation based on the first request data, the confidence data, and the second request data using a second model. The second model is configured to generate the policy based on a reward function. The processor is configured to control allocation of one or more resources for each of the first operation and the second operation based on the policy. By using the policy to allocate resources to the different operations of the first model, the utilization of available resources is maximized. This may reduce resource underutilization and improve overall efficiency of the execution of the first model. In particular, the system utilizes model metrics (such as the confidence data, the first request data and the second request data) of the first model and system metrics (such as number of resources available) in order to determine how resources should be assigned in a next batch when balancing resources between two or more interdependent workloads or operations. This may further lead to resource optimization and cost savings. The one or more second tasks are created based on the one or more first tasks. This may create implied semantics and interdependency between the second operation and the first operation. The interdependency of the operations is also used to generate the policy based on the reward function such that cost or resource allocation for interdependent operations is justified. This is crucial in cases where a particular operation is to be prioritized.

In other embodiments, the policy includes mapping data corresponding to an association between a state space and an action space. The state space is associated with at least one of the first request data, the confidence data, or the second request data. The action space is associated with the one or more resources. The state space may define the model metrics of the first model while the action space may define the system metrics for a computing environment in which the first model is implemented. The mapping data of the policy enables determination of how to allocate resources to the first operation and the second operation based on the model metrics and the system metrics.

In other embodiments, the processor is further configured to iteratively update the policy based on the reward function. This ensures that an optimal policy is determined for the allocation of the resources between the operations. Based on the optimized resource allocation for the first and the second operations, performance of the first model is improved.

In other embodiments, the confidence data indicates a confidence score associated with the output of each of the one or more first tasks. Moreover, the processor is further configured to determine a first task of the one or more first tasks having the confidence score lesser than a confidence threshold, and allocate the first task labelled with a user input as a second task of the one or more second tasks to the second queue. In this regard, the one or more first tasks of the first operation and the one or more second tasks of the second operation are competing operations having interdependency. The second tasks are added to the second queue by checking the confidence score of the output of each of the first tasks. In addition, the second tasks may be added to the second queue by associating a first task having low confidence score with a user input. This ensures that the second operation, i.e., fine-tune operation, is performed effectively.

In other embodiments, the one or more resources include at least one of: one or more processing resources, one or more memory resources, one or more network resources, or one or more accelerator resources.

In other embodiments, the processor is further configured to generate the reward function based on the first request data, the confidence data, and the second request data. The first request data and the second request data are interdependent. The reward function for generating the policy is formalized based on model metrics of the first model and system metrics associated with resources available. The reward function defines how to identify or generate an optimal policy that may be used in order to determine how resources should be assigned in the next batch when balancing resources between interdependent operations, i.e., the first operation and the second operation.

In other embodiments, the policy is associated with a Markov decision process (MDP). The MDP is formulated based on state(s), action(s) and the reward function associated with the interdependent first operation and the second operation of the first model. The policy generated based on the state(s), action(s), and the reward function in the MDP enables efficient execution of the operations of the first model for automated decision-making with regard to resource allocation.

In other embodiments, the first operation is an inference operation of the first model and the second operation is a fine-tune operation of the first model. For example, a model drift during the inference operation may increase an amount of data used for the finetuning operation of the first model. Alternatively, a well-tuned first model will decrease a number of inference operations that would have to be repeated. Due to the interdependency between the first operation or the inference operation and the first operation or the fine-tune operation, the system uses implied semantics, interdependency of the operations and the reward function in order to justify a cost associated with prioritizing any operation or allocating resources for the operations. The second model allows to consider factors such as workload priorities, resource availability, and system constraints to dynamically allocate resources to the inference operation and the fine-tuning operation based on their immediate requirements. The second model may generate the policy to implement an effective resource management strategy that strikes a balance between meeting immediate demands for the inference operation, facilitate model refinement through the fine-tune operation, and maximize resource utilization in resource-constrained environments.

In other embodiments, the first model is associated with a plurality of queues, and the plurality of queues includes the first queue and the second queue. According to an example, the first model may have to perform multiple operations, such as the first operation, the second operation, and any other operation. A computing environment associated with the first model may have limited resources to conduct the execution of the multiple operations. In this regard, the system uses the second model to generate the policy based on the model metrics of the first model as well as the system metrics to allocate resources to automate a decision of when to perform each of the multiple operations and how much resources to allocated for performing each of the multiple operations. The second model is adaptive to the run-time environment in which the first model is executed by measuring an outcome of each stage of resource assignment and using that in planning for a next stage.

According to an aspect of the present disclosure, there is provided a computer-implemented method for resource allocation. The computer-implemented method includes processing one or more first tasks from a first queue using a first model. The one or more first tasks are associated with a first operation of the first model. The computer-implemented method includes determining a confidence score for an output of each of the one or more first tasks and allocating one or more second tasks to a second queue based on the confidence score. The one or more second tasks are associated with a second operation of the first model. The allocation of the at least one second task to the second queue is performed based on the confidence score associated with the output of the one or more first tasks. Due to this an interdependency exists between the first tasks in the first queue and the second tasks in the second queue. In other words, the implied semantics and the interdependency may exist between the first operation and the second operation of the first model. The computer-implemented method further includes determining first request data associated with the first queue, second request data associated with the second queue, and confidence data associated with the confidence score of each of the one or more first tasks. The computer-implemented method further includes generating a policy for resource allocation using a second model based on the first request data, the confidence data, and the second request data. The second model is configured to generate the policy based on a reward function. The computer-implemented method further includes controlling allocation of one or more resources for each of the first operation and the second operation based on the policy. As the first operation and the second operation are interdependent and the second model generates the policy based on the first request data, the confidence data, and the second request data. Therefore, the policy is generated based on model metrics and system metrics to determine how the one or more resources are assigned in a next stage when the one or more resources are to be balanced between the two interdependent operations.

In other embodiments, the first operation is an inference operation of the first model and the second operation is a fine-tune operation of the first model. For example, a model drift during the inference operation may increase an amount of data used for the fine-tune operation of the first model, while a well-tuned first model may decrease a number of inference operations that would have to be repeated. By optimizing resource allocation for the inference operation and the fine-tune operation, the performance metrics such as throughput, latency, and energy efficiency of the first model are improved. This may further enhance overall user experience.

In other embodiments, the policy includes mapping data corresponding to an association between a state space and an action space. The state space is associated with at least one of the first request data, the confidence data, or the second request data. The action space is associated with the one or more resources. The mapping data of the policy enables a determination of how to allocate resources to the first operation and the second operation based on the model metrics and the system metrics.

In other embodiments, the computer-implemented method further includes iteratively updating the policy based on the reward function. By iteratively updating the policy based on the reward function, an optimal policy is determined or generated. The optimal policy ensures that costs associated with conducting the operations, i.e., the first operation and the second operation, are minimized and rewards are maximized. The generated policy is iteratively updated to adapt to changes in workload dynamics and system conditions, enabling adaptive resource allocation in dynamic environments.

In other embodiments, the one or more resources are associated with at least one of an edge computing device, or an on-premises computing environment. The computing environment in which the first model is implemented is associated with constrained resources environment. As a result, managing resource allocation using the second model in such constrained environments improves throughput and efficiency of the first model.

In other embodiments, the one or more resources include at least one of: one or more processing resources, one or more memory resources, one or more network resources, or one or more accelerator resources.

In other embodiments, the computer-implemented method further includes generating the reward function based on the first request data, the confidence data, and the second request data. The first request data and the second request data are interdependent. The reward function maximizes reward while learning and generating the policy that defines how to allocate resources to interdependent operations.

According to an aspect of the present disclosure, there is provided a computer program product for resource allocation. The computer program product includes a computer-readable storage medium having program instructions embodied therewith, the program instructions executable by a processor to cause the processor to determine first request data associated with a first queue, wherein the first queue includes one or more first tasks associated with a first operation of a first model. The program instructions may further cause the processor to determine confidence data associated with an output of each of the one or more first tasks, allocate one or more second tasks to a second queue based on the confidence data of each of the one or more first tasks, and determine second request data associated with the second queue. The second queue includes the one or more second tasks associated with a second operation for the first model. The program instructions may further cause the processor to generate a policy for resource allocation using a second model based on the first request data, the confidence data, and the second request data. The second model is configured to generate the policy based on a reward function. The program instructions may further cause the processor to control allocation of one or more resources for each of the first operation and the second operation based on the policy. As a result, the efficiency and performance of the first model executing within constrained environment is enhanced.

In other embodiments, the first operation is an inference operation of the first model and the second operation is a fine-tune operation of the first model. Due to the allocation of the second task in the second queue based on the output of the one or more first tasks, interdependency is created between the first operation and the second operation. The interdependency defines relationships between the first tasks and the second tasks and their shared reliance on the one or more resources. The interdependency is used to justify costs associated with prioritizing an operation or to check how to perform resources allocation.

In other embodiments, the one or more resources are associated with at least one of: an edge computing device, or an on-premises computing environment.

In other embodiments, the policy includes mapping data corresponding to an association between a state space and an action space. The state space is associated with at least one of the first request data, the confidence data, or the second request data. The action space is associated with the one or more resources. The constraints based on the state space and the action space ensure that resource allocation decisions adhere to system limitations while maximizing utility or minimizing costs.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

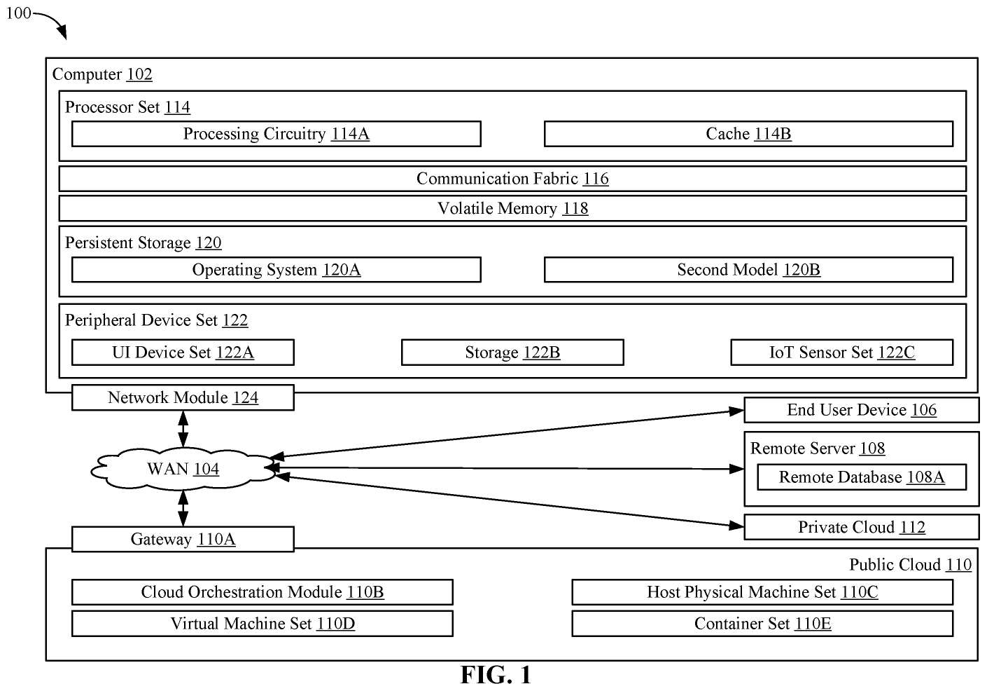

FIG. 1 is a diagram that illustrates a computing environment 100 for dynamic resource allocation based on a policy generated by a second model, in accordance with an embodiment of the disclosure. With reference to FIG. 1, there is shown the computing environment 100 that contains an example of an environment for the execution of at least some of the computer code involved in performing the inventive methods, such as a second model 120B that generates the policy for dynamic resource allocation among different operations. In addition to the second model 120B, computing environment 100 includes, for example, a computer 102, a wide area network (WAN) 104, an end-user device (EUD) 106, a remote server 108, a public cloud 110, and a private cloud 112. In this embodiment, the computer 102 includes a processor set 114 (including a processing circuitry 114A and a cache 114B), a communication fabric 116, a volatile memory 118, a persistent storage 120 (including an operating system 120A and the second model 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network, or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 114B and the other storage media discussed below. The program instructions, and associated data, are accessed by the processor set 114 to control and direct performance of the inventive methods. In the computing environment 100, at least some of the instructions for performing the inventive methods may be stored in the second model 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The Volatile Memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the second model 120B typically includes at least some of the computer code involved in performing the inventive methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments, storage 122B may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments, network control functions, and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The End User Device (EUD) 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present, the recommendation to an end user. In some embodiments, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize all resources of that computer, such as connected devices, files and folders, network shares, CPU power, and quantifiable hardware capabilities. However, programs running inside a container may use the contents of the container and devices assigned to the container, a feature which is known as containerization.

The private cloud 112 is similar to public cloud 110, except that the computing resources are available for use by a single enterprise. While the private cloud 112 is depicted as being in communication with the WAN 104, in other embodiments, a private cloud may be disconnected from the internet entirely and accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

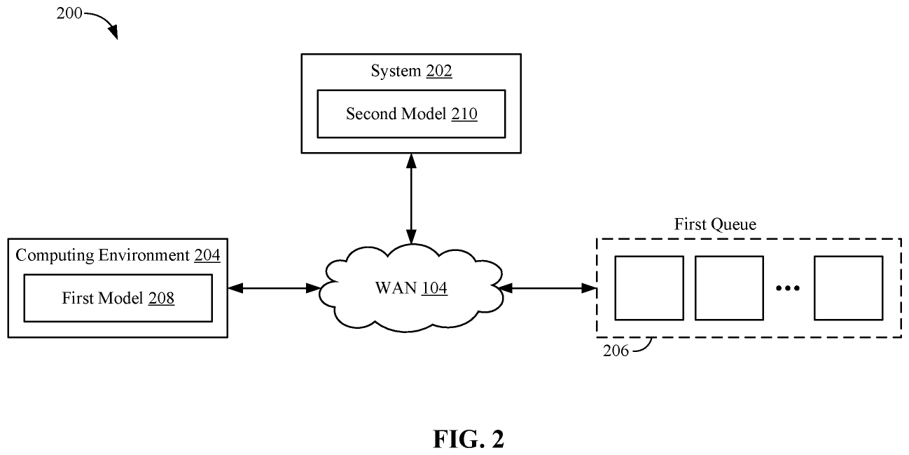

FIG. 2 is a diagram that illustrates a network environment 200 in which a system 202 for dynamic resource allocation is implemented, in accordance with an embodiment of the disclosure. FIG. 2 is explained in conjunction with elements from FIG. 1. The network environment 200 includes the system 202, a computing environment 204, and a first queue 206 of one or more first tasks. The network environment 200 may further include a first model 208 implemented within the computing environment 204, a second model 210 implemented by the system 202, and the WAN 104 of FIG. 1. In an embodiment, the system 202 may be an exemplary embodiment of the computer 102 of FIG. 1. Moreover, the second model 210 may be an exemplary embodiment of the second model 120B of FIG. 1.

The system 202 may include suitable logic, circuitry, interfaces, and/or code that may be configured to perform decision making with respect to resource allocation for executing operations of the first model 208. The system 202 may be configured to determine first request data associated with first task requests of the first queue 206. The first queue 206 includes the one or more first tasks associated with a first operation of the first model 208. The system 202 may be further configured to determine confidence data associated with an output of each of the one or more first tasks. The system 202 may be further configured to allocate one or more second tasks to a second queue based on the confidence data of each of the one or more first tasks. The system 202 may be further configured to determine second request data associated with the second queue (not shown in FIG. 2). The second queue includes the one or more second tasks associated with a second operation of the first model 208. The system 202 may be further configured to generate a policy for resource allocation using the second model 210 based on the first request data, the confidence data, and the second request data. The second model 210 is configured to generate the policy based on a reward function. The system 202 may be further configured to control allocation of one or more resources for each of the first operation and the second operation based on the policy. Examples of the system 202 may include, but are not limited to, a computing device, a virtual computing device, a mainframe machine, a server, a computer workstation, a smartphone, a cellular phone, a mobile phone, a gaming device, a consumer electronic (CE) device and/or any other device with trace calculation capabilities.

The computing environment 204 may include suitable logic, circuitry, and interfaces, and/or code that may be configured to store the first model 208. The computing environment 204 may be further configured to store the first model 208, store the first queue 206 including the one or more first tasks, cause the first model 208 to execute the one or more first tasks, and store outputs of the one or more first tasks executed by the first model 208. The computing environment 204 may be implemented as a server or a cloud server and may execute operations through web applications, cloud applications, HTTP requests, repository operations, file transfer, and the like. Other example implementations of the computing environment 204 may include, but are not limited to, a database server, a file server, a web server, a media server, an application server, a mainframe server, or a cloud computing server.

In one embodiment, the computing environment 204 may be implemented as a plurality of distributed cloud-based resources by use of several technologies that are well known to those ordinarily skilled in the art. A person with ordinary skill in the art will understand that the scope of the disclosure may not be limited to the implementation of the computing environment 204 and the system 202 as two separate entities. In certain embodiments, the functionalities of the computing environment 204 can be incorporated in its entirety or at least partially in the system 202 or vice versa, without a departure from the scope of the disclosure.

The first model 208 may receive the one or more first tasks for inference. For example, the one or more first tasks are received from users of the first model 208. The received one or more first tasks are stored within the first queue 206, for example, within the computing environment 204.

In an embodiment of the present disclosure, the first model 208 is a large-scale pre-trained neural network designed to learn general-purpose representations of natural language, images, or other data modalities. The first model 208 may be trained on a large corpus of data using, for example, unsupervised learning techniques, such as self-supervised learning or language modelling. Further, the first model 208 may be deployed for inference operation on new, unseen data inputs, such as the one or more first tasks in the first queue 206.

During an inference operation, the first model 208 processes input data, such as task data of a first task from the one or more first tasks through its layers. The first model 208 may transform the input data into a meaningful representation and may produce output predictions or classifications relevant to the first task at hand. In this manner, the first model 208 may produce outputs for the one or more first tasks. While the first model 208 processes some of the one or more first tasks from the first queue 206, other first tasks may be added to the first queue 206 simultaneously.

In operation, the system 202 is configured to determine first request data associated with the first queue 206. The first queue 206 includes the one or more first tasks associated with the first operation of the first model 208. For example, the first operation is an inference operation. Subsequently, the one or more first tasks are requests for inferences. The data associated with each of the one or more first tasks and data associated with the first queue 206 may indicate the first request data. For example, the first request data may include, but is not limited to, a queue length of the first queue 206.

The system 202 is further configured to determine confidence data associated with an output of each of the one or more first tasks. In an embodiment of the present disclosure, the confidence data may include confidence scores associated with each of the one or more first tasks executed by the first model 208. For example, the first queue 206 may be executed in a batch manner, such that the confidence data may include confidence scores of first tasks executed by the first model 208 in a current batch.

The system 202 is further configured to allocate one or more second tasks to a second queue (not shown in FIG. 2) based on the confidence data of each of the one or more first tasks. In an embodiment of the present disclosure, the second queue is generated based on the confidence data or the confidence scores of the first tasks executed by the first model 208 in the current batch. For example, a first task from the one or more first tasks and its output having a confidence score less than a confidence threshold is added to the second queue as a second task. In this manner, the one or more second tasks are added to the second queue based on the confidence data of the outputs of the one or more first tasks.

Further, the second queue includes the one or more second tasks that are associated with the second operation. As a result, although the second operation is different from the first operation, the second operation and the first operation are interdependent. For example, when the first operation relates to the inference operation of the first model 208, the second operation relates to fine-tune operation of the first model 208. As may be understood, the inference operation or the first operation includes generating outputs or predictions based on input data, i.e., the one or more first tasks. Further, the fine-tune operation or the second operation includes updating parameters of the first model 208 to adapt the first model 208 to a target task or a domain-specific while preserving learned representations. The fine-tune operation for the first model 208 is performed using the one or more second tasks.

The system 202 is further configured to determine the second request data associated with the second queue. The second queue includes the one or more second tasks associated with the second operation of the first model 208. In an embodiment of the present disclosure, the second request data may include, but is not limited to, a queue length for the second queue. The second request data may also include data associated with the one or more second tasks in the second queue.

The system 202 is further configured to generate the policy for resource allocation based on the first request data, the confidence data, and the second request data. The system 202 is configured to utilize the second model 210 to generate the policy for resource allocation. For example, the policy defines a set of rules or guidelines indicating how resources should be allocated to different operations or processes to achieve specific objectives. The policy defines a decision-making process for determining which operations receive resources, how resources are distributed among competing operations, and when resource allocations should be adjusted based on changing conditions. The policy for resource allocation for the operations, such as the first operation and the second operation of the model may be designed to optimize various objectives, such as maximizing throughput, minimizing latency, or minimizing resource consumption. For example, the second model 210 is configured to generate the policy based on the reward function. For example, the second model 210 is a reinforcement learning (RL)-model that is adaptive to run-time environment by measuring an outcome of each previous batch and/or current batch of resource assignment and feeding that into planning resource allocation for a next batch. Subsequently, the RL-based second model 210 learns an optimal policy for resource allocation for the next batch based on the first request data for the first operation during the next batch, the confidence data associated with confidence scores of the current batch and the second request data for the second operation during the next batch.

The system 202 is further configured to control allocation of one or more resources for each of the first operation and the second operation based on the policy. In this regard, the system 202 dynamically allocates one or more constrained resources associated with the computing environment 204 between two competing operations, such as the first operation and the second operation. In an example, the computing environment 204 is associated with an edge computing device, or an on-premises computing environment. As a result, the one or more resources of the computing environment 204 are constrained, not scalable and lack resiliency. Based on the policy generated by the second model 210, the system 202 is configured to balance multiple loads due to the multiple operations of the first model 208 within the constrained resources of the computing environment 204.

Examples of the one or more resources may include, but are not limited to, one or more processing resources (such as, GPUs, and CPUs), one or more memory resources, one or more network resources (such as network devices, network bandwidth, etc.), or one or more accelerator resources (such as, hardware accelerators, etc.).

While the first operation and the second operation of the first model 208 are explained as inference operation and fine-tune operation, respectively, this should not be construed as a limitation. In particular, the first operation and the second operation may be any two interdependent operations that may be performed by the first model 208 simultaneously or partly simultaneously. The first operation and the second operation may be selected from a plurality of operations of the first model 208. The first model 208 is associated with a plurality of queues corresponding to the plurality of operations, and the plurality of queues include the first queue 206 and the second queue. In certain cases, the system 202 is configured to generate the policy for resource allocation among two or more operations from the plurality of operations of the first model 208. Examples of the plurality of operations of the first model 208 may include, but is not limited to, data acquisition, data processing, model training, model tuning (such as fine-tuning, prompt-tuning, parameter efficient fine-tuning, etc.), prompt engineering, model serving, model alignment and model testing.

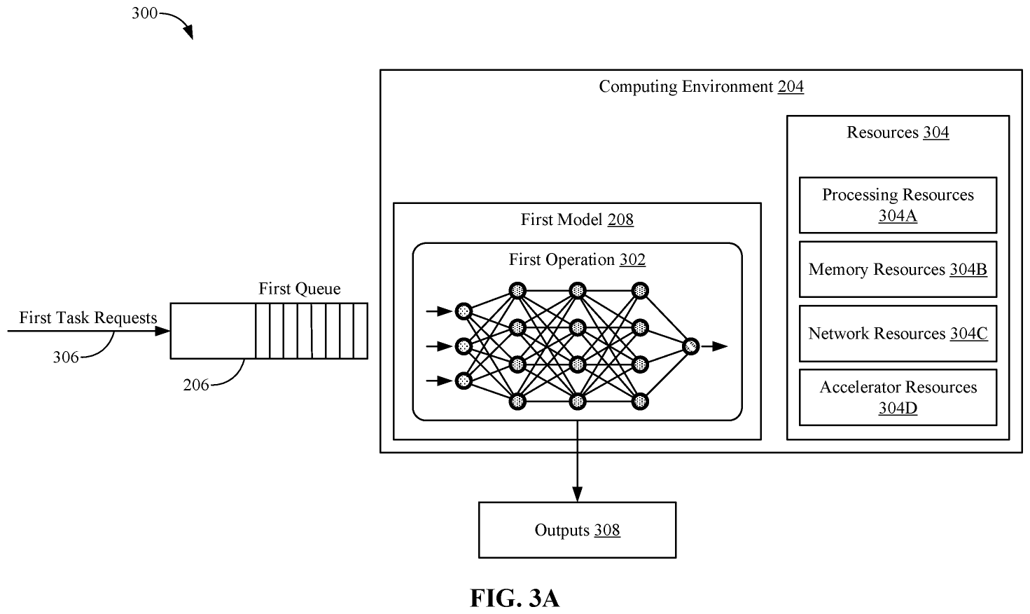

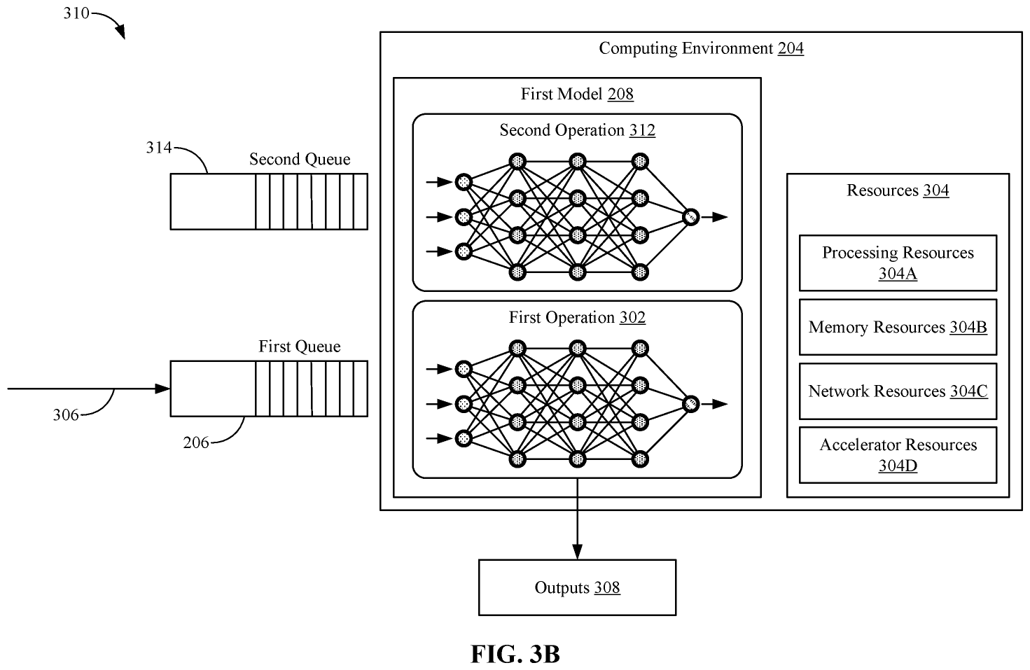

FIG. 3A and FIG. 3B are diagrams that depict execution of an exemplary first operation 302 and an exemplary second operation 312 associated with the first model 208, in accordance with an embodiment of the disclosure. FIG. 3A and FIG. 3B are described in conjunction with FIG. 2.

In particular, the first model 208 is implemented or deployed in the computing environment 204. In an embodiment of the present disclosure, the first model 208 is a transformer model that is implemented using deep learning frameworks, such as TensorFlow, PyTorch, or Hugging Face Transformers library. The first model 208 may be trained in a powerful computing infrastructure, such as high-performance GPUs or TPUs, due to the computational intensity of the training process. Once trained, the first model 208 may be deployed on and accessed through the computing environment 204. The computing environment 204 may provide access to the first model 208 depending on specific use case and deployment environment.

Deploying the first model 208 in the computing environment 204 involves making the first model 208 available for use. Subsequently, the first model 208 may perform the first operation 302 or other operations relevant to intended application of the first model 208. In this regard, the first model 208 may define an input format. In an example, the input format may depend on an architecture of the first model 208 and a type of data that the first model 208 processes. For example, the input format may indicate text data in a specific format, such as plain text or tokenized sequences.

Further, the first model 208 may receive first task requests 306 from user devices through an API endpoint or an interface established to receive input requests. The user devices associated with different users may be configured to send the first task requests 306 relating to processing of the one or more first tasks. In this manner, several users may raise first tasks that may be sent to the first model 208 for outputs and/or predictions.

In an embodiment of the present disclosure, a first task request from the first task requests 306 may be preprocessed before submitting input data, i.e., the first task request, to the first model 208. For example, the first task request may be preprocessed to ensure that input data for the first model 208 is formatted correctly and meets the requirements of the first model 208. Examples of the preprocessing operations may include, but are not limited to, tokenization, normalization, encoding, or other transformations depending on the model architecture and data type.

When managing multiple concurrent first task requests 306, the input data associated with the first task requests 306 may be queued in the first queue 206. The first task requests 306 may be queued to manage request processing by the first model 208 efficiently. Input queuing mechanisms, such as message queues (e.g., RabbitMQ®, Kafka®) or task queues (e.g., Celery) may be used to buffer the first task requests 306 and distribute them to the first model 208 for processing. The first task requests 306 or the one or more first tasks in the first queue 206 are processed by the first model 208 by performing the first operation 302 thereon. In an example, the first operation 302 is an inference operation, and the first model 208 processes the first task requests 306 to generate inference outputs.

In one example, the computing environment 204 is associated with an on-premises computing environment. In this regard, the first model 208 may be deployed on on-premises servers or data centers of an organization. The first model 208 may be deployed on servers within an infrastructure of the organization, and a user within the infrastructure may access the first model 208 through an internal network. In an embodiment of the present disclosure, a computer of the user may interact with the first model 208 by inputting data associated with a first task to a model server and receiving predictions or outputs over the internal network.

In another example, the computing environment 204 is associated with an edge computing device. In this regard, the first model 208 may be implemented directly on the edge computing device to ensure low-latency or offline capabilities. Examples of the edge computing devices may include, but are not limited to, smartphones, IoT devices, or edge servers. For example, when the first model 208 is deployed on the edge computing device, a user may access the first model 208 locally without requiring network connectivity. In an embodiment of the present disclosure, a computer of the user may interact with the first model 208 indirectly by sending input data associated with a first task to the edge computing device for processing and receiving predictions or outputs back.

In certain other examples, the computing environment 204 in which the first model 208 is deployed may be associated with a cloud-based computing environment having constrained resources.

Pursuant to embodiments of the present disclosure, the computing environment 204 may have one or more resources 304 that are constrained or non-scalable. In particular, resource usage of the first model 208 may vary depending on factors, such as the model size, complexity of tasks being performed, hardware specifications of the resources 304 of the computing environment 204, etc.

The resources 304 of the computing environment 204 may include, but is not limited to, processing resources 304A, memory resources 304B, network resources 304C, and accelerator resources 304D. In an embodiment of the present disclosure, the first model 208 may require the processing resources 304A to perform inference tasks, such as the one or more first tasks. Performing the inference tasks may involve processing data associated with the one or more first tasks through a neural network architecture of the first model 208 to generate output predictions or responses. The workload of the first model 208 may be managed by the processing resources 304A, such as the CPUs and/or the GPUs. The memory resources 304B may be used to store model parameters of the first model 208, intermediate computations, and input/output data during performing the one or more first tasks. The memory resources 304B may also be used to store model files, input data, and output results. The network resources 304C may correspond to network bandwidth that enables communication between edge devices where the first model 208 is deployed and cloud servers for certain tasks (e.g., transferring data, model updates). The network resources 304C may also include any other network devices used for communication while performing the operations of the first model 208. Further, the accelerator resources 304D may enhance the performance and efficiency of the first model 208 by providing specialized hardware resources optimized for deep learning computations. Examples of the accelerator resources 304D may include, but are not limited to, graphics processing units (GPUs), tensor processing units (TPUs), Field-Programmable Gate Arrays (FPGAs), Application-Specific Integrated Circuits (ASICs), and neuromorphic processors.

Referring to FIG. 3A, a diagram 300 of execution of the exemplary first operation 302 associated with the first model 208 is shown, in accordance with an embodiment of the disclosure. In particular, the first model 208 may receive the first task requests 306 that may be stored in the first queue 206 as the one or more first tasks. Further, the first model 208 may perform the first operation 302 to process the one or more first tasks from the first queue 206 to generate outputs 308. In an example, the first operation is an inference or prediction operation. During the execution of the first operation 302 on a first task, the first model 208 may make predictions or draw conclusions from input data associated with the first task. During inference, the first model 208 takes the input data associated with the first task, processes it through its learned parameters and architecture, and produces output predictions or classifications without further training. Subsequently, the outputs 308 are inference or prediction outputs generated by the first model 208 in response to performing the first operation 302 on the one or more first tasks in the first queue 206.

Referring to FIG. 3B, a diagram 310 of execution of the exemplary first operation 302 as well as the exemplary second operation 312 associated with the first model 208 is shown, in accordance with an embodiment of the disclosure. In particular, the second operation 312 is interdependent on the first operation 302. In other words, the second operation 312 and the first operation 302 rely on each other or influence each other's execution. For example, when the first operation 302 is an inference operation then the second operation 312 is a fine-tune operation. Other examples of interdependent operations of the first model 208 may include, but are not limited to, training operation and fine-tune operation, inference operation and feedback loop operation, model adaptation operation and re-evaluation operation, data collection operation and model training operation, hyperparameter tuning operation and model performance operation, model deployment operation and monitoring operation.

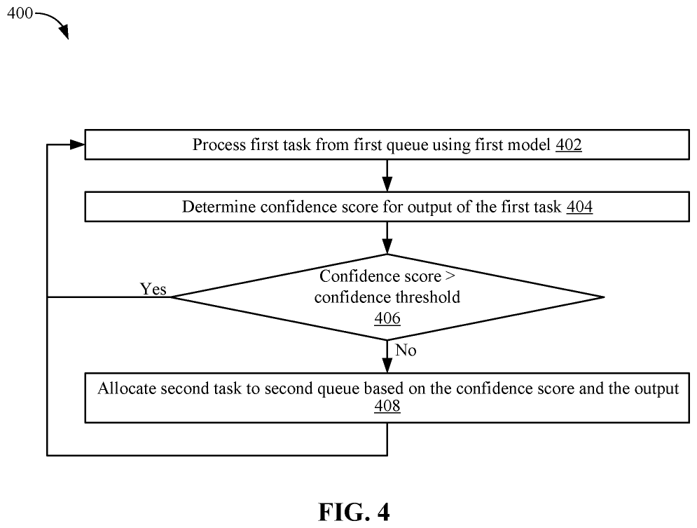

In an embodiment of the present disclosure, the second operation 312 is to be performed on one or more second tasks stored in a second queue 314. In an example, the one or more second tasks are added to the second queue 314 based on the outputs 308 generated by performing the first operation 302 on the one or more first tasks. Details of how the one or more second tasks are added to the second queue 314 based on the outputs 308 are further described in conjunction with FIG. 4.

Although two operations, i.e., the first operation 302 and the second operation 312, are shown to be performed by the first model 208, this should not be construed as a limitation. In other examples, the first model 208 may perform two or more interdependent operations. These interdependent operations may have to be performed simultaneously or concurrently.

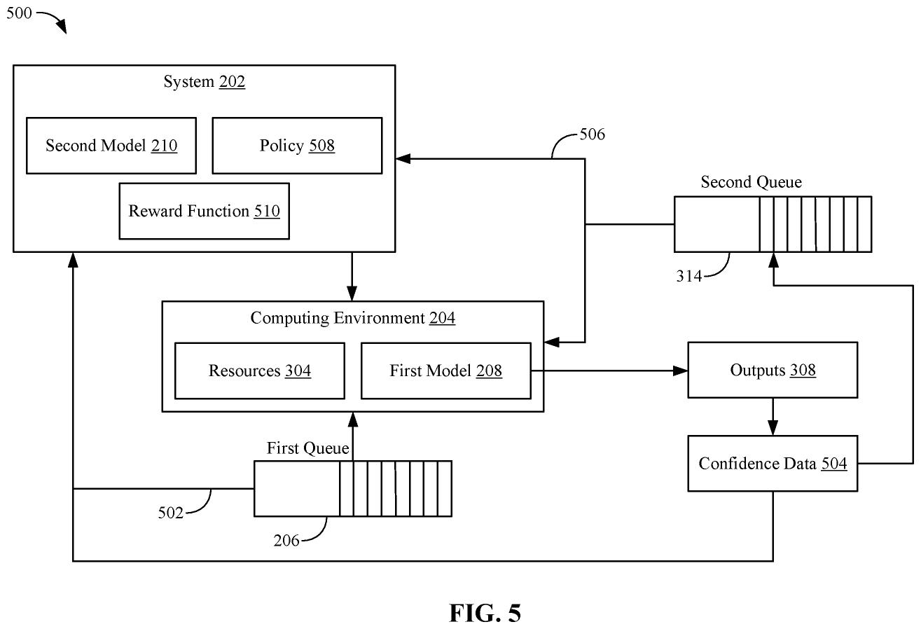

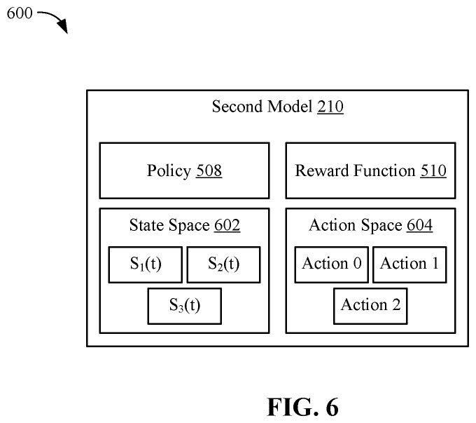

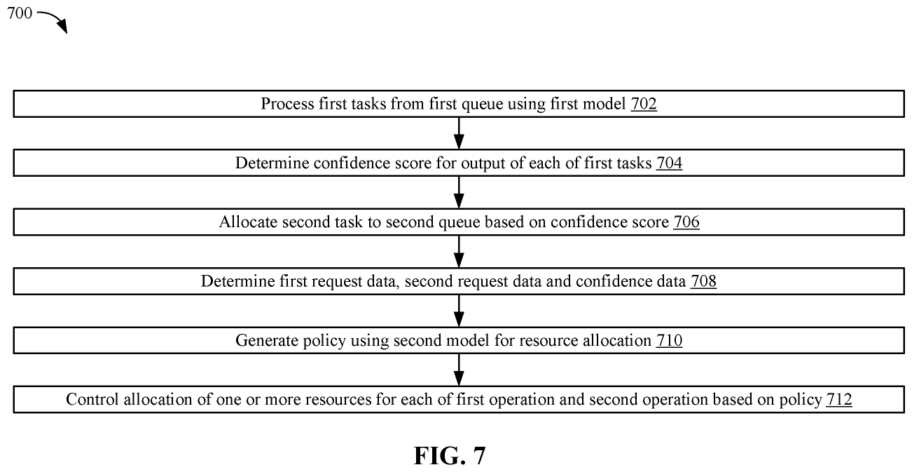

When the first model 208 is implemented on edge computing devices, on-premises computing environment and/or other devices with constrained resources 304, the resources 304 may limit a size of the first model 208 that may be deployed or a number of concurrent tasks that may be executed by the first model 208. As a result, workloads of the first model 208, such as execution of the first operation 302 and the second operation 312 may have to be optimized to run efficiently with the available resources 304. A manner in which the system 202 operates to dynamically allocate resources for the concurrent execution of the first operation 302 and the second operation 312 is described in detail in conjunction with FIG. 5, FIG. 6, and FIG. 7.

FIG. 4 is a flowchart 400 that illustrates an exemplary method for generating the second queue 314 for the second operation 312, in accordance with an embodiment of the disclosure. The FIG. 4 is explained in conjunction with FIG. 2, FIG. 3A and FIG. 3B.

The first task requests 306 or inference requests are stored in the first queue 206 until they are served or processed. During the first operation 302 or the inference operation, a batch of the first task requests 306 or the one or more first tasks from the first queue 206 is sampled to predict the outputs 308. Such batch of first tasks from the first queue 206 that is currently being executed is referred to as a current batch.

At 402, a first task from the first queue 206 is processed using the first model 208. The first model 208 performs the first operation 302 based on input data associated with the first task. In this regard, the first model 208 processes the input data associated with the first task to generate an output. In an example, the first task is from the current batch.

At 404, a confidence score for the output of the first task is determined. The confidence score may be a measure of 'a confidence of the first model 208 in the prediction or inference output for the first task. The confidence score may indicate a level of certainty or uncertainty associated with the output, which may be expressed as a probability or a numerical score between 0 and 1.

At 406, a determination is made to ascertain if the confidence score of the output is greater than a confidence threshold or not. In an embodiment of the present disclosure, the confidence score of the output is compared with the confidence threshold.

If the confidence score is greater than the confidence threshold, then the output of the first task under consideration is dropped. The confidence score that is higher than the confidence threshold may indicate higher confidence in the output. The first model 208 then proceeds to process another first task in the current batch from the first queue 206.

Alternatively, if the confidence score is less than the confidence threshold, then, at 408, a second task is allocated to the second queue 314. In an embodiment of the present disclosure, the second task is generated and added to the second queue 314 based on the output of the first task under consideration and the confidence score of the output.

In an embodiment of the present disclosure, the second task added to the second queue 314 is associated with fine-tune operation of the first model 208. In an example, the system 202 is configured to allocate the second tasks to the second queue 314 based on a confidence score of an output of each of the first tasks in the first queue 206. For example, the second tasks correspond to first tasks having the corresponding confidence score lesser than the confidence threshold. Moreover, the second tasks may include first tasks having low confidence score labeled with a user input. In an embodiment of the present disclosure, the user input associated with the first task under consideration is received. For example, the user input may indicate a correct or ground truth output for the first task. Subsequently, the first task is tagged with the output generated by the first model 208 and the correct output received as the user input along with the confidence score. The tagged first task is added to the second queue 314 as the second task. This second task may be processed by the first model 208 for fine-tuning thereof.

The operations of 402, 404 and 406 may be repeated until each task in the current batch of the one or more first tasks in the first queue 206 is completed.

To this end, confidence scores of the outputs 308 generated in the current batch using the first model 208 are used as a metric for assessing the performance of the first model 208. Further, the one or more second tasks are allocated to the second queue 314 based on the confidence data of output of each of the one or more first tasks that are executed in the current batch. Subsequently, each of inference outputs from the outputs 308 having low confidence score, i.e., confidence score lesser than the confidence threshold, are tagged and used to allocate the one or more second tasks in the second queue 314. The second queue 314 is associated with the fine-tune operation of the first model 208. In an embodiment of the present disclosure, after the processing of the one or more second tasks in the second queue 314, the second queue 314 is emptied. Thereafter, a current version of the first model 208 is updated for performing inference or the first operation 302 on a new batch of first tasks or inference requests in the first queue 206. However, while the first model 208 performs the second operation to process the one or more second tasks for fine-tuning, the first model 208 may also have to perform the first operation to process the next batch of one or more first tasks from the first queue 206 for inference. To this end, the first model 208 may have to perform the first operation and the second operation concurrently, at least for some time.

Subsequently, resource allocation for the first model 208 needs to be performed to enable processing of the second queue 314 for fine-tuning as well as processing of the one or more first tasks in the next batch of the first queue 206. In this regard, the system 202 is configured to control allocation of the resources 304 for executing the first operation 302 on the one or more first tasks in the first queue 206 and the second operation 312 on the one or more second tasks in the second queue 314.

FIG. 5 is a diagram 500 that illustrates resource allocation for executing the exemplary first operation 302 and the exemplary second operation 312 associated with the first model 208, in accordance with an embodiment of the disclosure. FIG. 5 is explained in conjunction with FIG. 2, FIG. 3A, FIG. 3B and FIG. 4.

The system 202 is configured to determine first request data 502 associated with the first queue 206. The first queue 206 includes the one or more first tasks associated with the first operation 302 of the first model 208. In an embodiment of the present disclosure, the first request data 502 includes a length of the first queue 206 at time t. The first request data 502 indicates the length of the first queue 206 at the time t, particularly, after the execution of the current batch of first tasks in the first queue 206. Subsequently, the first request data 502 indicates a number of first tasks currently present in the first queue 206 that are pending for processing by the first model 208 at the time t. These one or more first tasks currently present in the first queue 206 may correspond to the current batch for execution of the first operation 302.

The system 202 is configured to determine confidence data 504 associated with an output of each of the one or more first tasks. For example, the confidence data 504 is associated with the outputs 308 of the one or more first tasks executed in the current batch, such as before time t. The confidence data 504 may include confidence score of each of the outputs 308.

The system 202 is configured to determine second request data 506 associated with the second queue 314. The second queue 314 includes the one or more second tasks associated with the second operation 312 of the first model 208. In an embodiment of the present disclosure, the one or more second tasks are added to the second queue 314 based on the outputs 308 of the first tasks executed in the current batch before the time t. The second request data 506 may indicate a length of the second queue 314 or a number of the second tasks in the second queue 314 at time t.

Further, the system 202 is configured to generate a policy 508 for resource allocation based on the first request data 502, the confidence data 504, and the second request data 506 using the second model 210. The second model 210 is configured to generate the policy 508 based on a reward function 510. Details of generating the policy 508 based on the reward function 510 are further discussed in conjunction with FIG. 6.

FIG. 6 is a diagram 600 of an exemplary problem formulation for resource allocation using the second model 210, in accordance with an embodiment of the disclosure. FIG. 6 is explained in conjunction with FIG. 2, FIG. 3A, FIG. 3B, FIG. 4 and FIG. 5. In an embodiment of the present disclosure, a problem for resource allocation is formulated using a Markov decision process (MDP) problem that is learnt to generate the policy 508 for resource allocation.

In an embodiment of the present disclosure, the policy 508 is associated with a Markov decision process (MDP). For example, the second model 210 is based on MDP that learns the policy 508 for resource allocation. The MDP may be used to model decision-making problems in situations where outcomes are partially random and partially under the control of a decision-maker. The MDP may be used in reinforcement learning to formalize decision-making problems and find optimal strategies to maximize cumulative rewards over time.

The second model 210 based on the MDP may be used for resource allocation and defining the reward function 510. In an example, the MDP for the second model 210 is defined for resource allocation problem based on a state space 602, an action space 604, state transitions, and the reward function 510.

In an embodiment, the state space 602 may include one or more states of the MDP. The one or more states may define a set of possible situations or configurations that the first model 208 may be in. The states may represent current conditions associated with the first model 208, which may evolve over time based on actions taken by the decision-maker, i.e., the system 202. According to an embodiment, the state space 602 for the MDP of the second model 210 is generated based on three states. The three states may be defined as:
s₁(t): First request data 502: Length of the first queue 206 at time t
s₂(t): Second request data 506: Length of the second queue 314 at time t
s₃(t): Confidence data 504: Confidence scores of the outputs 308 generated using the first model 208 on the current batch of first tasks or inference requests.

In an embodiment of the present disclosure, the states of the state space 602 are generated based on a combination or compounding of the three states, i.e., s₁(t), s₂(t), and s₃(t).

In an embodiment of the present disclosure, the action space 604 may include one or more actions of the MDP. The one or more actions may define a set of possible outcomes or choices that the decision-maker or the system 202 may take in each of the one or more states of the state space 602. The one or more actions represent available options for influencing the behavior of the first model 208 or transitioning between the one or more states. The action space 604 at the time, t, may be defined as:

$$a ( t ) ∈ [ 0 , N ]$$

where N is a total number of resources 304 available for executing the first operation 302 and the second operation 312 of the first model 208.

For example, for processing the next batch of the one or more first tasks or inference requests, i.e., after time t, and the one or more second tasks or fine-tune requests, the processing resources 304A, such as the GPUs and/or the CPUs may be allocated among the operations of the first model 208. Further, a=i implies an action of performing the one or more second tasks or executing the second queue 314 after time, t, with i GPUs and performing the next batch of one or more first tasks or executing the first queue 206 after the time, t, with (N−i) GPUs.

According to an embodiment of the present disclosure, a total number of GPUs for performing the first operation 302 and the second operation 312 is N=2. In such a case, the action space 604 for the MDP of the second model 210 may include three actions. The three actions may be defined as: action 0, action 1 and action 2. The action 0 may correspond to executing the first operation 302 to execute the first queue 206 after the time, t, on N=2 GPUs. The action 1 may correspond to executing the first operation 302 to execute the first queue 206 after the time, t, on i=1 GPU, and executing the second operation 312 to execute the second queue 314 after the time, t, on 1 (i.e., N−i=2−1=1) GPU. Further, the action 2 may correspond to executing the first operation 302 to execute the first queue 206 after the time, t, on the CPU, and executing the second operation 312 to execute the second queue 314 after the time, t, on 2 GPUs.

In an embodiment of the present disclosure, a(t)=1 corresponds to action 1, i.e., execute the first operation 302 on 1 GPU, and execute the second operation 312 on 1 GPU when N=2.

In an embodiment of the present disclosure, the state transitions for the MDP may correspond to each of the one or more states in the state space 602. The state transitions may define a probability of transitioning from one state to another when a particular action is taken. Particularly, the state transitions may indicate the stochastic nature of the computing environment 204 where the first model 208 is implemented and determine how the first model 208 evolves over time. Corresponding to the three states used for generating the states the state space 602, the MDP may have three state transitions.

In an embodiment of the present disclosure, a state transition of a first state associated with the length of the first queue 206, i.e., s₁(t)→s₁(t+1), may be based on a rate of receiving the first task requests 306 in the first queue 206 and current action space 604, a(t). The action space 604 may indicate how many resources or GPUs are currently allocated for executing the first operation 302 on the first queue 206. In another example, a state transition of a second state associated with the length of the second queue 314, i.e., s₂(t)→s₂(t+1), may be based on the current action space 604, a(t), and s₃(t). It may be noted that the action space 604 may indicate how many resources or GPUs are currently allocated for executing the second operation 312 on the second queue 314 and s₃(t) indicates state of the confidence data 504 of the outputs 308 of the first tasks executed by the first model 208. To this end, s₃(t) may indicate how frequently a second task is added to the second queue 314 based on the confidence data 504. The confidence data 504 indicates a performance, i.e., model metrics, of the first model 208. In yet another example, a state transition of a third state associated with the confidence data 504, i.e., s₃(t)→s₃(t+1), may also be based on the current action space 604, a(t), and s₃(t). For example, the action space 604 may indicate a speed of execution of the first queue 206 and the second queue 314 based on corresponding resources, and the s₃(t) indicates state of the confidence data 504 of the outputs 308 while executing the first operation 302 on the current batch of first tasks in the first queue 206 and having confidence scores lesser than the confidence threshold.

To this end, the formulation of the MDP is based on system parameters indicating resources available for executing the operations of the first model 208, as well as model metrics indicating performance of the first model 208. In an example, the system parameters are indicated by the action space 604 indicating the availability of the resources for executing the first operation 302 and the second operation 312. Further, the model metrics are indicated by the confidence data 504 indicating the performance of the first model 208 while executing the first tasks in the current batch, i.e., before the time t.

Thereafter, the reward function 510 of the MDP of the second model 210 is defined. In an example, the reward function 510 may assign a numerical reward to each state-action pair, representing an immediate benefit or cost associated with taking a particular action in a given state. The numerical rewards may influence the behavior of the second model 210 by providing feedback on a desirability of different actions, such as action 0, action 1 and action 2 of the action space 604.

In an embodiment of the present disclosure, the system 202 is configured to generate the reward function 510 based on the first request data 502, the confidence data 504, and the second request data 506. As may be noted, the first request data 502, such as a length of the first queue 206 and the second request data 506, such as a length of the second queue 314 are interdependent. For the reward function 510 associated with resource allocation problems, the reward function 510 may be designed to capture various objectives such as maximizing throughput, minimizing latency, optimizing resource utilization, and/or satisfying service-level agreements (SLAs). The reward function 510 guides the behavior of the system 202 for resource allocation by providing feedback on desirability of different actions of the action space 604 and influencing the generation and selection of the policy 508. For example, the policy 508 is an optimal resource allocation policy.

In an embodiment of the present disclosure, the reward function 510 for the MDP of the second model 210 is defined as:

$$r ( s ( t ) , a ( t ) ) = {T}_{1} ( t ) + {λ}_{2} {T}_{2} ( t ) + {λ}_{3} {T}_{3} ( t )$$

$$where$$

$${T}_{1} ( t ) = ( 1 - \frac{{s}_{1} ( t + 1 )}{{B}_{1}} ) ,$$

$${T}_{2} ( t ) = ( 1 - \frac{{s}_{2} ( t + 1 )}{{B}_{2}} ) , and$$

$${T}_{3} ( t ) = ( {s}_{3} ( t + 1 ) - {s}_{3} ( t ) )$$

and B₁ and B₂ are normalization constants. λ₂ and λ₃ are hyperparameters to control how much importance to give to accuracy and latency.

According to an embodiment of the present disclosure, the policy 508 may include mapping data that associates the state space 602 and the action space 604. The policy 508 is a mapping from the state space 602 to the action space 604. The state space 602 corresponds to the first request data 502, s₁(t), or the length of the first queue 206, the confidence data 504, s₃(t), and the second request data 506, s₂(t), or the length of the second queue 314. Further, the action space 604 is associated with the one or more resources 304 of the computing environment 204, for example, the GPUs and the CPUs for processing the one or more first tasks and the one or more second tasks.

In an embodiment of the present disclosure, the policy 508 is indicated as: π(s(t))→a(t). For example, a generated policy may be iteratively updated based on the reward function 510 to generate the optimal policy, π*, 508. The optimal policy 508 may indicate a best action for each state of the state space 602, such that a summation of selection of these best actions for each state results in maximum cumulated reward.

In an embodiment of the present disclosure, the second model 210 is configured to take the three current states, i.e., s₁(t), s₂(t) and s₃(t) or the state space 602 at time, t, as input and predict a cumulative reward associated with selection of each action (logits) of the action space 604. Based on the actions, the policy 508 is generated that indicates a path having a maximum cumulative reward based on a collection or summation of rewards for multiple actions within the path. In an example, the second model 210 may utilize deep Q-learning techniques to solve the MDP to learn the policy 508 for allocation of the resources 304 for the first operation 302 and the second operation 312 after time t, such as during time (t+1).

In an embodiment of the present disclosure, the second model 210 is trained on a sequence of data indicated by

$${\{ ( s ( t ) , a ( t ) , r ( t ) ) \}}_{t = 0}^{T} ,$$

where a(t) is generated using any policy of choice. In particular, a predefined number of episodes of the data may be collected for training the second model 210. Each episode from the predefined number of episodes may include a given number of timesteps, say 250-350 timesteps. Further, each episode of data may run on the second model 210 for a given amount of time, say 30 minutes, 1 hour, 2 hours, 5 hours, etc. In this manner, the second model 210 is trained to formulate problem for resource allocation for the first model 208 based on the system parameters of the computing environment 204 and generate the policy 508 by maximizing reward of the reward function 510 while solving the formulated problem.

The system 202 is configured to control allocation of the resources 304, such as the processing resources 304A or the GPUs and the CPUs of the computing environment 204 for each of the first operation 302 and the second operation 312 based on the policy 508. For example, at least one action from the action space 604 that yields maximum cumulative reward for the time t+1 is identified from the policy 508. Based on the at least one action, certain resources, such as i, from the resources 304 or the processing resources 304A are allocated for executing the first operation 302 on the next batch of the one or more first tasks in the first queue 206. Further, remaining resources from the resources 304 or the processing resources 304A, such as N−i, are allocated for executing the second operation 312 on the one or more second tasks in the second queue 314. In this manner, the first operation 302 and the second operation 312 are performed simultaneously while managing allocation of resources among the first operation 302 and the second operation 312 dynamically during different time periods. For example, the allocation of resources during the time t+1 may be further updated during time t+2.

FIG. 7 is a flowchart 700 that illustrates an exemplary method for dynamic resource allocation based on the policy 508, in accordance with an embodiment of the disclosure. Details of the FIG. 7 are described in conjunction with FIG. 2, FIG. 3A, FIG. 3B, FIG. 4, FIG. 5, and FIG. 6.

At 702, the one or more of the first tasks are processed from the first queue 206 using the first model 208. In an embodiment of the present disclosure, the system 202 is configured to process the current batch of the one or more first tasks that are associated with the first operation 302 of the first model 208. For example, the first operation 302 is an inference operation, and the one or more first tasks are inference tasks.

At 704, a confidence score for an output of each of the one or more first tasks are determined. In an embodiment of the present disclosure, the system 202 is configured to determine the confidence scores for the outputs 308 of each of the one or more first tasks performed in the current batch.

At 706, at least one second task is allocated to the second queue 314 based on the confidence score. In an embodiment of the present disclosure, the system 202 is configured to compare the confidence score of each of the outputs 308 with the confidence threshold. On determining a confidence score of an output to be lesser than the confidence threshold, the system 202 is configured to allocate a second task.

In an example, a first task of the one or more first tasks having the confidence score lesser than the confidence threshold is determined. Further, the first task is allocated as a second task of the one or more second tasks to the second queue 314 labelled with a user input. IN this regard, for example, the second task includes the first task associated with the output having the confidence score lesser than the confidence threshold. Moreover, the first task is tagged or labeled with an expert input or the user input, the output from the first model 208 and the corresponding confidence score. In this manner, low confidence predictions are used as fine-tuning data (or by using a teacher model where teacher knowledge is used at inference time to enhance student model).

At 708, the first request data 502, the second request data 506 and the confidence data 504 are determined. In an embodiment of the present disclosure, the system 202 is configured to determine the first request data 502 associated with the first queue 206. The first request data 502 may indicate a length of the first queue 206. The system 202 is configured to determine the second request data 506 associated with the second queue 314. The second request data 506 may indicate a length of the second queue 314. The system 202 is configured to determine the confidence data 504 associated with the confidence score of each of the one or more first tasks executed by the first model 208 in the current batch. The confidence data 504 may indicate outputs of first tasks having confidence scores lesser than the confidence threshold.

At 710, the policy 508 is generated using the second model 210 for resource allocation. In an embodiment of the present disclosure, the system 202 is configured to use the second model 210 to formulate a resource allocation problem based on current state of the first model 208 at time t, i.e., the first request data 502, the confidence data 504, and the second request data 506. Further, the second model 210 is trained to solve the resource allocation problem to learn and generate the policy 508 based on the reward function 510. In an example, the second model 210 may solve an MDP problem to generate the policy 508 while maximizing rewards.

At 712, allocation of the one or more resources 304 is controlled for each of the first operation 302 and the second operation 312 based on the policy 508. In an embodiment of the present disclosure, the system 202 is configured to identify at least one action associated with the maximum reward for the reward function 510. Based on the at least one action associated with the maximum reward, certain resources from the resources 304 are allocated for executing the first operation 302 on the next batch of the one or more first tasks in the first queue 206 and remaining resources from the resources 304 are allocated for executing the second operation 312 on the one or more second tasks in the second queue 314. A manner of resource allocation among the first operation 302 and the second operation 312, as well as other interdependent operations in other cases, may be dynamically updated over time to ensure high throughput and reduced latency of the first model 208.

Various embodiments of the disclosure may provide a non-transitory computer readable medium and/or storage medium having stored thereon, instructions executable by a machine and/or a computer to operate a system (e.g., the system 202) for dynamic resource allocation based on the policy 508. The instructions may cause the machine and/or computer to perform operations that include determining the first request data 502 associated with the first queue 206, wherein the first queue 206 includes one or more first tasks associated with the first operation 302 of the first model 208. The operations further include determining the confidence data 504 associated with an output of each of the one or more first tasks. The operations further include allocating the one or more second tasks to the second queue 314 based on the confidence data 504 of each of the one or more first tasks. The operations further include determining the second request data 506 associated with the second queue 314, wherein the second queue 314 includes one or more second tasks associated with the second operation 312 for the first model 208. The operations further include generating the policy 508 for resource allocation using the second model 210 based on the first request data 502, the confidence data 504, and the second request data 506. The second model 210 is trained to generate the policy based on the reward function 510. The operations further include controlling allocation of one or more resources 304 for each of the first operation 302 and the second operation 312 based on the policy.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
memory that stores instructions;
a processor configured to execute the instructions to:
determine first request data associated with a first queue, wherein the first queue comprises one or more first tasks associated with a first operation of a first model;
determine confidence data associated with an output of each of the one or more first tasks;
allocate one or more second tasks to a second queue based on the confidence data of each of the one or more first tasks;
determine second request data associated with the second queue, wherein the second queue comprises the one or more second tasks associated with a second operation of the first model;
generate, using a second model, a policy for resource allocation based on the first request data, the confidence data, and the second request data, wherein the second model is configured to generate the policy based on a reward function; and
control allocation of one or more resources for each of the first operation and the second operation based on the policy.

2. The system of claim 1, wherein the policy comprises mapping data that associates a state space and an action space, and wherein the state space corresponds to at least one of: the first request data, the confidence data, or the second request data, and the action space is associated with the one or more resources.

3. The system of claim 1, wherein the processor is further configured to
iteratively update the policy based on the reward function.

4. The system of claim 1, wherein the confidence data indicates a confidence score associated with the output of each of the one or more first tasks, and wherein the processor is further configured to:
determine a first task of the one or more first tasks having the confidence score lesser than a confidence threshold; and
allocate the first task labelled with a user input as a second task of the one or more second tasks to the second queue.

5. The system of claim 1, wherein the one or more resources comprise at least one of: one or more processing resources, one or more memory resources, one or more network resources, or one or more accelerator resources.

6. The system of claim 1, wherein the processor is further configured to
generate the reward function based on the first request data, the confidence data, and the second request data, wherein the first request data and the second request data are interdependent.

7. The system of claim 1, wherein the policy is associated with a Markov decision process (MDP).

8. The system of claim 1, wherein the first operation is an inference operation of the first model and the second operation is a fine-tune operation of the first model.

9. The system of claim 1, wherein the first model is associated with a plurality of queues, and wherein the plurality of queues comprises the first queue and the second queue.

10. A computer-implemented method comprising:
processing, using a first model, one or more first tasks from a first queue, wherein the one or more first tasks are associated with a first operation of the first model;
determining a confidence score for an output of each of the one or more first tasks;
allocating one or more second tasks to a second queue based on the confidence score, wherein each of the one or more second tasks is associated with a second operation of the first model;
determining
first request data associated with the first queue,
second request data associated with the second queue, and
confidence data associated with the confidence score of each of the one or more first tasks;
generating, using a second model, a policy for resource allocation based on the first request data, the confidence data, and the second request data, wherein the second model is configured to generate the policy based on a reward function; and
controlling allocation of one or more resources for each of the first operation and the second operation based on the policy.

11. The computer-implemented method of claim 10, wherein the first operation is an inference operation of the first model and the second operation is a fine-tune operation of the first model.

12. The computer-implemented method of claim 10, wherein the policy comprises mapping data that associates a state space and an action space, and wherein the state space corresponds to at least one of: the first request data, the confidence data, or the second request data, and the action space is associated with the one or more resources.

13. The computer-implemented method of claim 10, further comprising
iteratively updating the policy based on the reward function.

14. The computer-implemented method of claim 10, further comprising.
determining a first task of the one or more first tasks having the confidence score lesser than a confidence threshold; and
allocating the first task labelled with a user input as a second task of the one or more second tasks to the second queue.

15. The computer-implemented method of claim 10, wherein the one or more resources comprise at least one of: one or more processing resources, one or more memory resources, one or more network resources, or one or more accelerator resources.

16. The computer-implemented method of claim 10, further comprising
generating the reward function based on the first request data, the confidence data, and the second request data, wherein the first request data and the second request data are interdependent.

17. A computer program product comprising a computer readable storage medium having program instructions embodied therewith, the program instructions executable by a processor to cause the processor to:
determine first request data associated with a first queue, wherein the first queue comprises one or more first tasks associated with a first operation of a first model;
determine confidence data associated with an output of each of the one or more first tasks;
allocate one or more second tasks to a second queue based on the confidence data of each of the one or more first tasks;
determine second request data associated with the second queue, wherein the second queue comprises the one or more second tasks associated with a second operation of the first model;
generate, using a second model, a policy for resource allocation based on the first request data, the confidence data, and the second request data, wherein the second model is configured to generate the policy based on a reward function; and
control allocation of one or more resources for each of the first operation and the second operation based on the policy.

18. The computer program product of claim 17, wherein the first operation is an inference operation of the first model and the second operation is a fine-tune operation of the first model.

19. The computer program product of claim 17, wherein the confidence data indicates a confidence score associated with the output of each of the one or more first tasks, and wherein the program instructions cause the processor to:
determine a first task of the one or more first tasks having the confidence score lesser than a confidence threshold; and
allocate the first task labelled with a user input as a second task of the one or more second tasks to the second queue.

20. The computer program product of claim 17, wherein the policy comprises mapping data that associates a state space and an action space, and wherein the state space corresponds to at least one of: the first request data, the confidence data, or the second request data, and the action space is associated with the one or more resources.
